(19) United States
(12) Patent Application Publication
(10) Pub. No.: US 2005/0136740 A1
(43) Pub. Date: Jun. 23, 2005

(54) Premolded housing

(76) Inventor: Ronny Ludwig, Reutlingen (DE)

Correspondence Address: KENYON & KENYON, ONE BROADWAY, NEW YORK, NY, 10004, US

(21) Appl. No.: 11/016,634

(22) Filed: Dec. 17, 2004

(30) Foreign Application Priority Data
Dec. 20, 2003 (DE) 103 60 203.8

(51) Int. Cl. H01R 9/03

(52) U.S. Cl. 439/610

(57) ABSTRACT

A premolded housing for receiving a component. The housing includes a housing body made of a plastic material or molding compound material, a leadframe of metal, partially molded into the housing body, having a plurality of connector pins projecting from a connecting side of the housing body, for contacting a substrate, a die pad for receiving the component, and two side support areas connected to the die pad via direction-changing areas, the direction-changing areas projecting from housing body on opposite sides and side support areas being situated outside of the housing body, and side support areas and the connector pins extending in the same connecting direction for installation on the substrate. After the soldering tabs and the side support areas have been bent over, the premolded housing is mounted vertically on a substrate, for example a circuit board, and in particular receives a thermopile chip for a gas sensor.

### FIELD OF THE INVENTION

The present invention relates to a premolded housing for receiving a detector chip, a component made up of such a premolded housing and a chip received therein, as well as a device having a substrate and such a component.

### BACKGROUND INFORMATION

Premolded housings have a housing body which may be made of a plastic material or a molding compound based on epoxy resin, and a generally multiple-piece supporting strip of metal, generally called the leadframe. The premolded housing is produced in a molding process by extrusion-coating the leadframe with the plastic material or molding compound. Connector pins or housing tabs for contacting on a circuit board protrude, generally parallel to the housing floor or a possible die pad, generally on two sides or on all four sides of the premolded housing. A detector chip may subsequently be set into the premolded housing—onto the housing floor or preferably onto a middle area of the leadframe used as a die pad—and affixed by soldering or gluing, and contacted with the connector pins via wire bonds. The premolded housing is then mounted flat on a substrate, for example a circuit board, for example by gluing or soldering.

In gas sensors, which are used in the automotive industry for example to detect leakage in a CO₂ air conditioning system or to determine gas concentrations in the air being breathed, generally the temperature difference caused by absorption of infrared radiation in gas-specific wavelength ranges is measured as thermoelectric voltage, using a source of infrared radiation, such as an incandescent lamp operated in the low current range, and a radiation detector such as a thermopile. For the radiation detector, a detector chip, which may be in particular a thermopile chip, is often placed in a premolded housing as described above. The thermopile chip is usually placed on the floor of the premolded housing, for example on a die pad, so that an optical axis runs at an angle of 90_ to the floor of the premolded housing and thus to the circuit board. Because of their mechanical, optical or thermal properties, generally the detector chips may not be completely coated with plastic or a molding compound, so that the use of molded housings is unsuitable; however, in the case of premolded housings the radiation may enter through the open front of the premolded housing. The radiation source is generally positioned on another substrate, for example an additional circuit board, which must be optically aligned and positioned using a relatively complex procedure with respect to the premolded housing of the radiation detector.

### SUMMARY

A premolded housing, component, and device according to an example embodiment of the present invention may have the particular advantage that using relatively little manufacturing effort and relatively low manufacturing costs, a space-saving installation and simple and precise optical alignment is possible. According to the present invention, vertical installation of the premolded housing on a substrate—in particular a circuit board—is possible, whereby the generally tight lateral installation space may be significantly reduced.

According to the present invention, vertical mounting of the premolded housing saves substrate area, so that a smaller lateral installation space is needed. This is beneficial both for optical and for non-optical applications. With this type of vertical mounting, the premolded housing allows simple and inexpensive incorporation of stress-sensitive chips. With the vertical installation of a premolded housing having an optical component, the optical axis of the optical chip is not run vertical, but parallel or at a slight angle to the substrate. Thus, it is possible to mount a plurality of optical elements on a substrate, for example the premolded housing according to the present invention having an incorporated detector chip and a radiation source, so that it is possible using only one circuit board to design a complete optical system, e.g., a gas sensor having a radiation source and a radiation detector including an absorption path, and possibly a reflector device for focusing the radiation. In particular, a plurality of radiation detectors, each made up of a premolded housing and an incorporated detector chip, may be positioned on the substrate opposite a shared radiation source. A radiation filter may be provided at the open front side of the premolded housing, i.e., in the optical axis in front of the incorporated detector chip.

The manufacturing costs for a vertically mountable premolded housing are substantially the same as for conventional premolded housings, since no additional manufacturing steps are necessary. Since the premolded housing has an unstructured, smooth front side or upper face without connector pins, a standard populating process on the substrate is possible.

Above the leadframe in a lateral direction, a heat dispersing device and an electrical coupling to the substrate are possible, so that electromagnetic compatibility may be ensured. Furthermore, all relevant surfaces and contacts in the premolded housing may be passivated.

The design of the premolded housing according to the present invention, having a housing body and laterally extending side support areas that may be bent over in direction-changing areas, allows great stability and great variability in the installation when mounted vertically, depending on the installation space and the need for accessibility of the soldering points. The side support areas may optionally be bent in one of two directions, and furthermore, soldering tabs of the side support areas and of the connector pins may optionally also be bent in one of two directions.

Cost-effective and rapid manufacturing of the premolded housing is possible by molding the housing on a supporting strip or leadframe strip, followed by cutting or stamping out the leadframe, preferably with one cut, and bending over the side support areas.

### BRIEF DESCRIPTION OF THE DRAWINGS

The present invention is explained below based on some example embodiments.

FIG. 1 shows a section of a leadframe strip having a plurality of premolded housings which are extrusion molded around identical, repeating leadframe structures.

FIG. 2 shows a 10-pole premolded housing according to one embodiment, with a leadframe from FIG. 1 after being stamped out of the leadframe strip and before the leadframe is bent.

FIG. 3 shows a front view into the premolded housing according to FIG. 2 after all the soldering tabs, both from the side support areas and from the connections, have been bent over in one direction, and after the side support areas have been bent.

FIG. 4 shows a top view of a corresponding 6-pole premolded housing after the soldering tabs have been bent in the direction of the housing opening and the side support areas have been bent toward the rear of the premolded housing.

FIG. 5 shows a top view of an embodiment corresponding to FIG. 4, having the side support areas bent toward the front of the housing.

FIG. 6 shows a top view of an embodiment corresponding to FIG. 5, but having soldering tabs bent toward the outside, i.e., toward the rear of the housing.

FIGS. 7a, b show the premolded housing from FIG. 4 in a side view and a section of a side view.

FIG. 8 shows a gas sensor on a substrate having a radiation detector and a radiation source according to the present invention.

FIG. 9 shows a top view of a gas sensor having multiple radiation detectors according to the present invention.

### DETAILED DESCRIPTION OF EXAMPLE EMBODIMENTS

A leadframe strip 1 is manufactured, for example as a stamped part, from a metal, for example copper, and has a continuous ladder-shaped frame 4 with webs 4a, and a plurality of leadframe structures 5, prestamped in frame 4 and arranged in sequence in a direction of symmetry P, for leadframes 2 to be separated out later.

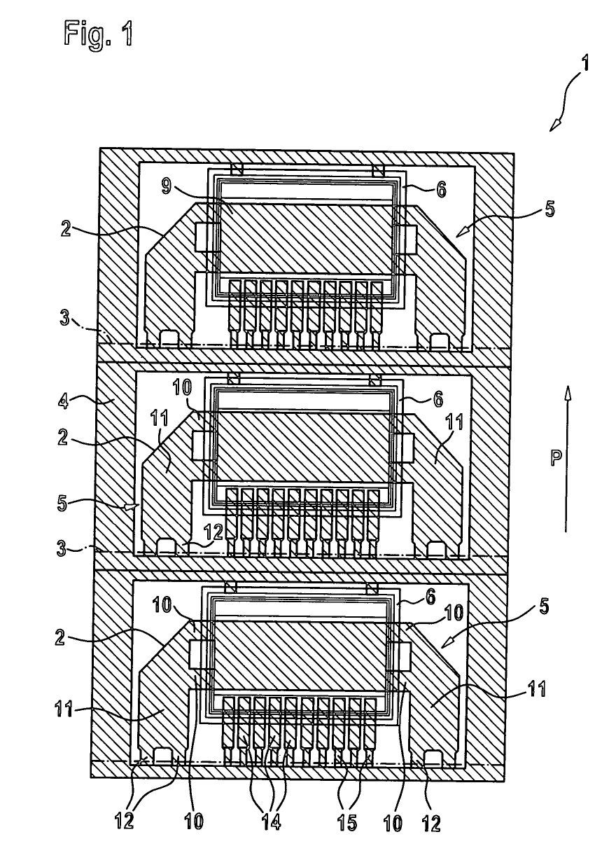

According to an example embodiment of the present invention, housing bodies 6 may be manufactured directly by extrusion coating leadframe structures 5 in unseparated leadframe strip 1 with a plastic material or a molding compound based on synthetic resin. In FIG. 1 the positions of premolded housing 6 are already drawn in with lines on the individual leadframe structures 5.

Each leadframe 2 has in its middle area a die pad 9, which is connected in both lateral directions, i.e., orthogonally to the direction of symmetry P—through a direction-changing area 10 to a left and right side support area 11. Side support areas 11 each extend downward, i.e., opposite the direction of arrow P—away from direction-changing areas 10, and each have two soldering tabs 12 at their lower end.

In addition, each leadframe 2 has a plurality of connector pins 14—according to FIG. 1 ten of them—, which are not connected to middle die pad 9, in order to enable differing contacting, via die pad 9 of the chip incorporated later and connector pins 14. Connector pins 14 protrude downward from housing body 6, and taper down to narrower soldering tabs 15 at their lower end.

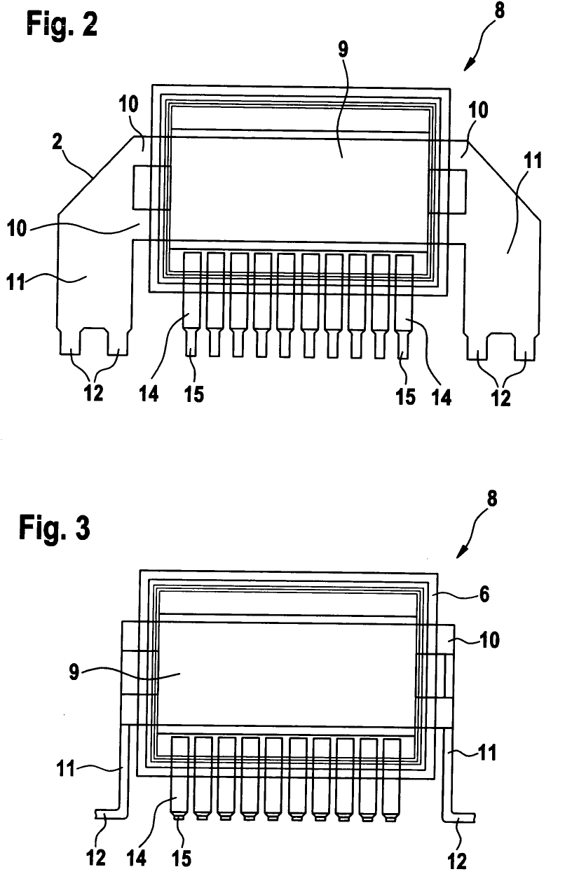

According to FIG. 2, leadframe 2 is molded into premolded housing 9 in such a way that direction-changing areas 10 are each halfway covered with the injected material, and thus serve in the subsequent bending as articulations for adjoining side support areas 11, which are positioned outside of premolded housing 6. In addition, connector pins 14 are also partially—e.g., approximately halfway—cast into premolded housing 6, so that their lower parts with soldering tabs 15 protrude outward.

Individual leadframe structures 5 are connected by their soldering tabs 12 and their soldering tabs 15 to the webs 4a of leadframe strip 1, which run in the transverse direction. By separating or trimming along straight cutting lines 3, the individual leadframes 2 are subsequently detached from leadframe strip 1; a premolded housing shown in FIG. 2 may be separated by each cut along cutting line 3.

Premolded housing 8 shown in FIG. 3 is formed starting from FIG. 2 by first bending soldering tabs 12, 15 of side support areas 11 and connector pins 14 by 9_, in order to permit mounting and contacting—as will be explained later—on a circuit board. Then, side support areas 11 are bent at right angles, i.e., by 90_ to the rear in direction-changing areas 10, which function as articulations.

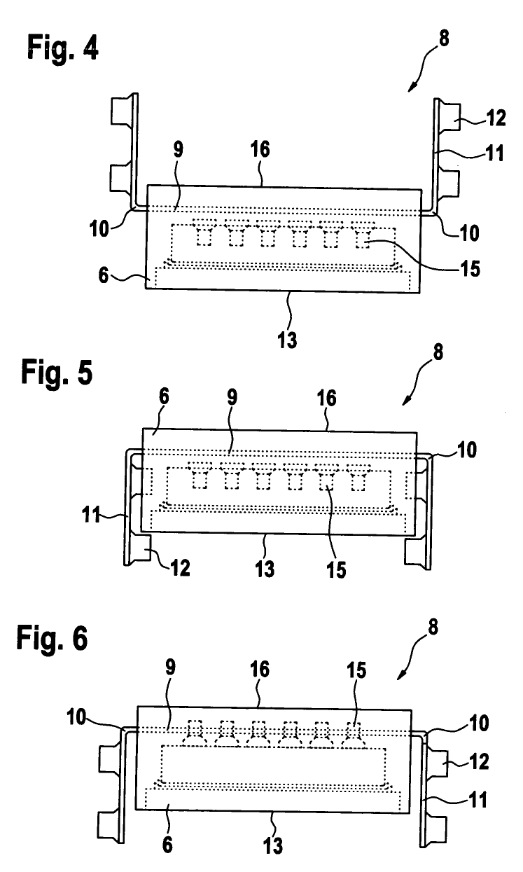

FIG. 4 shows an example embodiment of a six-pole premolded housing 8, which is manufactured by molding in six connector pins 14 and a die pad 9 having direction-changing areas 10 and side areas 11. Here, all soldering tabs 12 are bent toward the housing opening, and side support areas 11 are then bent toward the rear—i.e., toward the floor of housing body 6.

In the example embodiment of FIG. 5, in contrast to the example embodiment of FIG. 4, side support areas 11 are bent toward the front, i.e., toward a front side 13 of housing body 6, soldering tabs 12 here too being bent as in FIG. 4.

In the example embodiment of FIG. 6, in contrast to the example embodiments of FIGS. 4 and 5, soldering tabs 12 and 15 are bent in the other direction, and side support areas 11 are bent as in FIG. 5, so that soldering tabs 12 are bent outward—i.e., in the opposite direction from FIG. 5—in order to allow better inspection of the soldering points, which are offset laterally from housing body 6.

The example embodiments shown in FIGS. 3 through 6 may optionally be combined in regard to the direction in which side support areas 11, soldering tabs 12 and 15 are bent, in conformity with the corresponding contacting conditions and installation conditions of premolded housing 8.

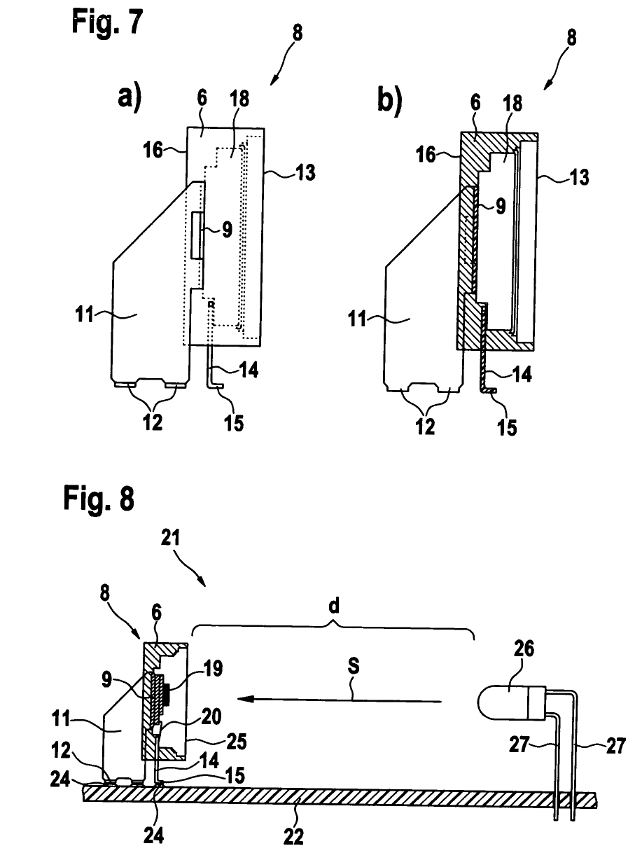

FIGS. 7a and 7b show a side view and sectional view from the side of premolded housing 8 from FIG. 4 before installation on a circuit board. Housing body 6 has in its interior a free space 18, and is at least partially open on its front side 13, in order to receive the radiation being detected, for example, in optical applications.

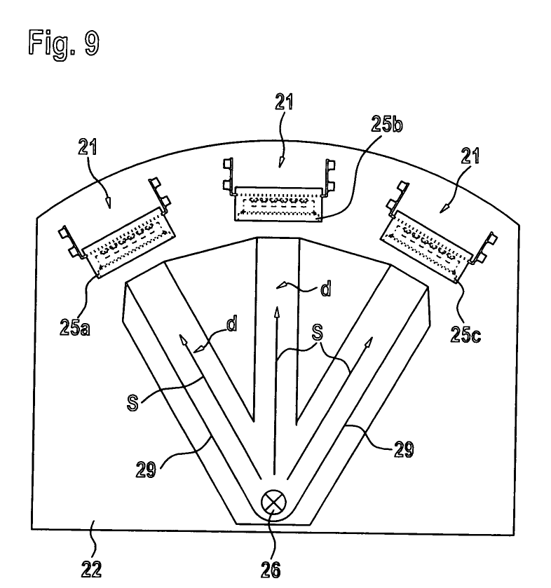

FIG. 8 shows the basic configuration of a radiation detector 21, which is formed by premolded housing 8 and a thermopile chip 19 incorporated into premolded housing 8, the chip being attached by its bottom to die pad 9 and making contact with the individual connector pins 14 through bonding wires 20. Radiation detector 21 is bonded to a circuit board 22 through soldering tabs 12 and 15 of side support areas 11 and connector pins 14, by means, for example, of solder 24 or contact adhesive. Here the entire premolded housing 8 made up of housing body 6 and leadframe 2 stands vertically, which means that die pad 9 and the floor of housing body 6 are perpendicular to circuit board 22, so that incorporated thermopile chip 19 is able to receive and detect radiation S which is parallel to circuit board 22. To this end, an incandescent lamp operated in the low current range as IR source 26 makes contact through its connections 27 with circuit board 22 and emits infrared radiation S, which is detectable by thermopile chip 19. Distance d between IR source 26 and thermopile chip 19 functions as absorption path d, in which a gas component, for example CO₂, is detectable. A cover and a radiation filter 25 may be placed on front 13 of housing body 6, which allow only IR radiation of a selected wavelength range to pass.

According to FIG. 9, a plurality of radiation detectors 21 incorporated vertically on circuit board 22 are provided, each made up of a premolded housing 8 and a thermopile chip 19, together with a shared IR radiation source 26. It is possible here to provide different radiation filters 25a, 25b and 25c having different filter properties on front 13 of housing body 6. For signal amplification, a reflector device 29 may be installed on circuit board 22, which focuses and guides radiation S from the one IR radiation source 26 to the individual radiation detectors 21.

1. A premolded housing for receiving a component, comprising:
a housing body made of one of a plastic material or molding compound material; and
a leadframe made of metal and partially molded into the housing body, the leadframe including a plurality of connector pins projecting from a connecting side of the housing body for contacting a substrate, a die pad for receiving the component, and two side support areas connected to the die pad via direction-changing areas, the direction-changing areas projecting from the housing body on opposite sides, the side support areas being situated outside of the housing body, and the side support areas and the connector pins extending in a same connecting direction for installation on the substrate.

2. The premolded housing as recited in claim 1, wherein the side support areas are angled with respect to the die pad due to bending of the direction-changing areas.

3. The premolded housing as recited in claim 1, further comprising:
bendable soldering tabs situated at the outer ends of the connector pins and the side support areas.

4. The premolded housing as recited in claim 3, wherein the soldering tabs of the side support areas are situated at a same level as the soldering tabs of the connector pins.

5. The premolded housing as recited in claim 1, wherein the housing body has a housing floor and an at least partially open front side located opposite the housing floor.

6. A component, comprising:
a premolded housing including a housing body made of one of a plastic material or molding compound, and a leadframe made of metal partially molded into the housing body, the leadframe including a plurality of connector pins projecting from a connecting side of the housing body, for contacting a substrate, a die pad for receiving the component, and two side support areas connected to the die pad via direction-changing areas, the direction-changing areas projecting from the housing body on opposite sides, the side support areas being situated outside of the housing body, and the side support areas and the connector pins extending in a same connecting direction for installation on the substrate; and
at least one chip attached to the die pad and bonded to the connector pins via bonding wires.

7. The component as recited in claim 6, wherein the component is a radiation detector, and wherein the chip is a radiation detector chip, at least part of the chip being located beneath an open front side of the premolded housing to receive radiation.

8. The component as recited in claim 7, wherein at least one of an aperture and a radiation filter is on a front side of the housing body.

9. A device, comprising:
a substrate;
at least one component, the component including a premolded housing including a housing body made of one of a plastic material or molding compound, and a leadframe made of metal partially molded into the housing body, the leadframe including a plurality of connector pins projecting from a connecting side of the housing body, for contacting a substrate, a die pad for receiving the component, and two side support areas connected to the die pad via direction-changing areas, the direction-changing areas projecting from the housing body on opposite sides, the side support areas being situated outside of the housing body, and the side support areas and the connector pins extending in a same connecting direction for installation on the substrate; and
at least one chip attached to the die pad and bonded to the connector pins via bonding wires;
wherein the component is mounted on the substrate using soldering tabs of the connector pins and of the side support areas, the die pad and a housing floor of the housing body being perpendicular to the substrate.

10. The device as recited in claim 9, wherein the device is a gas sensor, the component is a radiation detector, and a radiation source is mounted on the substrate, the radiation source emitting IR radiation via an absorption path to the radiation detector.

11. The device as recited in claim 10, wherein a plurality radiation detectors are situated on the substrate opposite the radiation source.

12. The device as recited in claim 11, wherein radiation filters having different filter characteristics are situated on front sides of the housing bodies of the plurality of radiation detectors.

13. The device as recited in claim 10, further comprising:
a reflector device mounted on the substrate around the absorption path to focus the radiation emitted by the radiation source.

14. A method for manufacturing a premolded housing, comprising:
a) manufacturing a leadframe strip of metal, having a frame and a plurality of leadframe structures, formed in the frame, following each other in sequence in a manufacturing direction, the leadframe structures each having a die pad, two side support areas connected to the die pad and the frame via direction-changing areas, and having connector pins connected to the frame, the connector pins having soldering tabs;
b) extrusion coating the leadframe structures using a plastic material or molding compound material and forming a housing body, which at least partially receives and fixes the leadframe structures in an area of the die pad and the connector pins;
c) separating the leadframe out of the leadframe strip; and
d) bending the soldering tabs and bending of the side support areas in a direction of one of a housing floor or of a front side of the housing body.

15. The method as recited in claim 14, wherein the leadframes are separated out of the leadframe strip along cutting lines which are orthogonal to the manufacturing direction.
